(19) United States
(12) Patent Application Publication
(10) Pub. No.: US 2005/0071865 A1
(43) Pub. Date: Mar. 31, 2005

(54) Annotating meta-data with user responses to digital content

(76) Inventor: Fernando C. M. Martins, Hillsboro, OR (US)

Correspondence Address: Schwegman, Lundberg, Woessner & Kluth, P.A., P.O. Box 2938, Minneapolis, MN, 55402, US

(21) Appl. No.: 10/677,145

(22) Filed: Sep. 30, 2003

(51) Int. Cl. H04H 9/00; H04N 7/16

(52) U.S. Cl. 725/10; 725/9; 725/12

(57) ABSTRACT

The embodiments of the present invention relate generally to digital content and more specifically to annotating meta-data describing digital content. An exemplary embodiment of the present invention is a computerized method comprising receiving data representing a user's reaction to digital content and generating through computer automated operations meta-data based on the user's reaction. Another embodiment of the invention is a method that includes identifying a user of digital content, collecting the user's reactions to digital content, generating meta-data associated with the digital content based on the user's reactions, and storing the meta-data by the a receiver.

### FIELD

The embodiments of the present invention relate generally to digital content and more specifically to annotating meta-data describing digital content.

### BACKGROUND

A variety of ranking systems exist today. Some of the ranking systems are voluntary systems and others are involuntary systems.

One example of a voluntary ranking system is a restaurant guide such as the Zagat's restaurant guides or other similar restaurant guides. The Zagat's restaurant guide provides a ranking based on active feedback received from customers worldwide. In other words, the customer who visited the restaurant must voluntarily complete and submit a predefined restaurant review form to the organization compiling the restaurant guide. Thus, this type of ranking system requires active participation from the restaurant customers. However, a significant drawback to a voluntary ranking system is the fact that it requires people to actively do something. Because not all people will respond, the ranking is based on less than all of the user's opinions. The ranking may also be biased because people with strong positive or negative opinions may be more likely to respond than other people who do not have a reason to respond.

In contrast, other ranking systems are implemented without requiring explicit user action. For example, Google is currently a popular Internet search engine that relies on an involuntary system for ranking the usefulness of web pages. Web pages are ranked by the amount of cross-references (also referred to as links)-measured in a web crawl. The amount of cross-references may be a good gauge of the usefulness of a particular web page to a user. Anonymous web users act as involuntary reviewer/critics when they considered a web page worthy of a link. Thus, the ranking system used by the Google search engine is derived from the structure of the web without active user involvement in the process.

Another example of an involuntary ranking system is the Citation Index. The Citation Index is a tool to grade the quality/novelty of scientific papers after publication. The Citation Index compiles the number and list of cross-references that a given paper receives from other researchers in their publications. The Citation Index does not require authors of papers to submit a list of cross-references to the organization compiling the index. Rather, like the Google Internet search engine, the Citation Index implements involuntary ethnographic ranking without requiring explicit user action.

However, no involuntary ethnographic ranking system is currently available for grading media content. One reason for this is the lack of automatic methods for meta-data generation. The lack of automatic methods for meta-data generation is a significant barrier to efficient browsing and sharing of digital content.

For example, people watch good and bad movies, but there is no mechanism to efficiently provide feedback, other than Nielsen ratings and biased opinions of movie critics. Good movies make people cry and laugh, bad movies make people fast forward to skip the boring sections or even abandon viewership. Some content has a few precious segments embedded in vast amounts of long boring predictable sequences. Manual meta-data annotation to indicate good movies and bad movies is not an efficient solution.

In another example, people collect images. Photo albums contain gems and also contain massively boring content. People viewing the collections of images are forced to withstand boredom to get to the gems over and over. Previous viewers do not leave a trace to help others find the gems. Traditional methods (i.e., manual annotations) are not efficient because there is no reason for the viewer to provide an evaluation of a piece of content just seen.

Recently, digital packaging of data and respective meta-data have emerged as an attractive infrastructure solution to content centric distribution and management of digital assets, including 3D models, images, video, and audio—vis-à-vis MPEG-21. In these systems, meta-data has been used to hold packaging manifests for packaged media, to detail and extend semantic content description as well as to provide infrastructure for content addressability to the final user. Traditionally, meta-data is attached to the content upon creation, and most of the meta-data pertains to the description of tangible properties of the multimedia package. Any user specific meta-data is currently input manually which creates a barrier to wide-spread adoption.

For these and other reasons, there is a need for embodiments of the present invention.

### BRIEF DESCRIPTION OF THE DRAWINGS

FIG. 1 is a block diagram of a general computing environment according to one embodiment of the invention.

FIG. 2 is a functional block diagram of one embodiment of a receiver, such as the receiver shown in FIG. 1.

FIG. 3 is a block diagram of one embodiment of a data structure for digital content and associated meta-data.

FIG. 4 is a more detailed block diagram of an example embodiment of a processing module such as the processing module shown in FIG. 2.

FIG. 5 is a flow diagram of a method according to an example embodiment of the invention.

FIG. 6 is a flow diagram of a method according to another example embodiment of the invention.

FIG. 7 is a block diagram of an electronic system for annotating meta-data with user responses in accordance with one embodiment of the invention.

### DESCRIPTION OF THE EMBODIMENTS

In the following detailed description of the embodiments, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the present inventions. The following detailed description is, therefore, not to be taken in a limiting sense, and the scope of the present inventions is defined only by the appended claims.

Embodiments of systems and methods for annotating meta-data with user responses to digital content are described. Digital content refers to digital representations of created works including audio (such as music and spoken words), artwork (such as photographs and graphics), video, text, multimedia and the like; as well as digital representations of new forms of content that become available in the future.

The detailed description is divided into four sections. In the first section, a system overview is provided for embodiments of the invention. In the second section, methods of using example embodiments of the invention are described. In the third section, various example scenarios are described. In the fourth section, a general hardware and operating environment in conjunction with which embodiments of the invention can be practiced is described.

System Overview. A system overview of example embodiments of the invention is described by reference to FIGS. 1, 2, 3 and 4.

FIG. 1 is a block diagram of a general computing environment according to one embodiment of the invention. The general computing environment 100 shown in FIG. 1 comprises originators 102 and receivers 104 of digital content. The terms “receiver” and “originator” are arbitrary in that one may also perform the operations of the other. Originators 102 and receivers 104 are in communication with each other over a network 106 such as an intranet, the Internet, or other network. An originator 102 provides digital content to one or more receivers 104 either at the request of the receiver 104 or at the initiative of the originator 102. In one embodiment, the originators 102 and the receivers 104 are peers in a peer-to-peer network. In an alternate embodiment, the originator 102 is a server and the receivers 104 are clients in a client-server network.

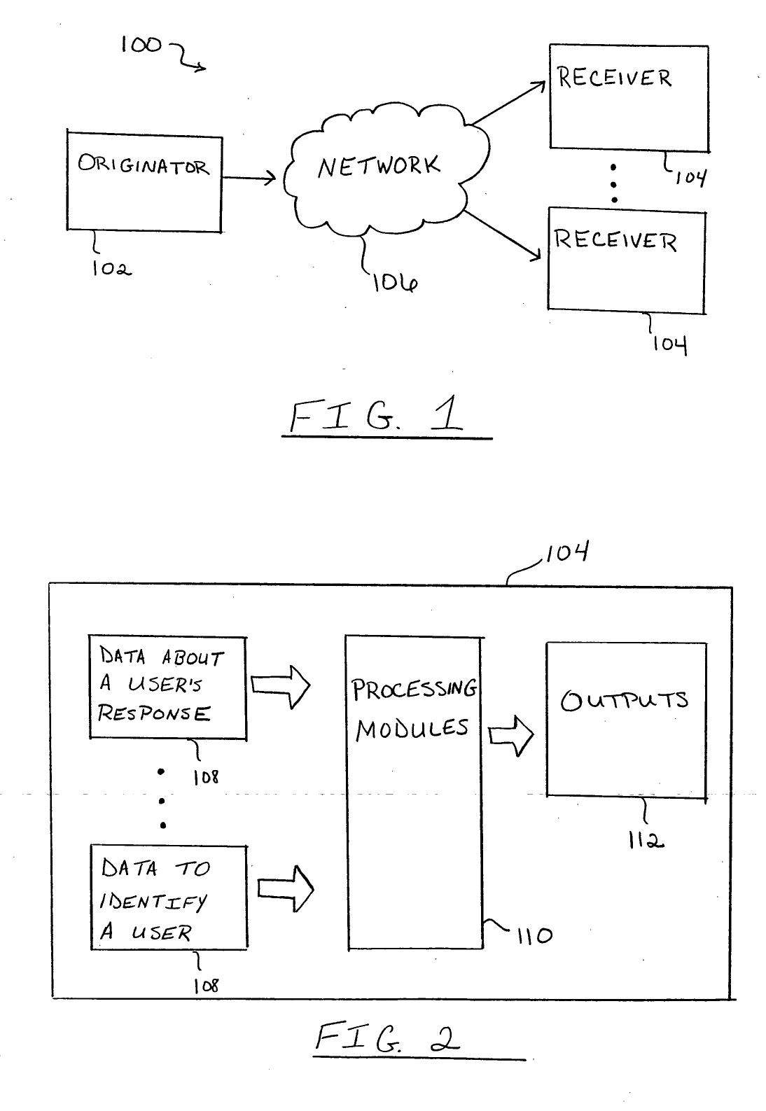

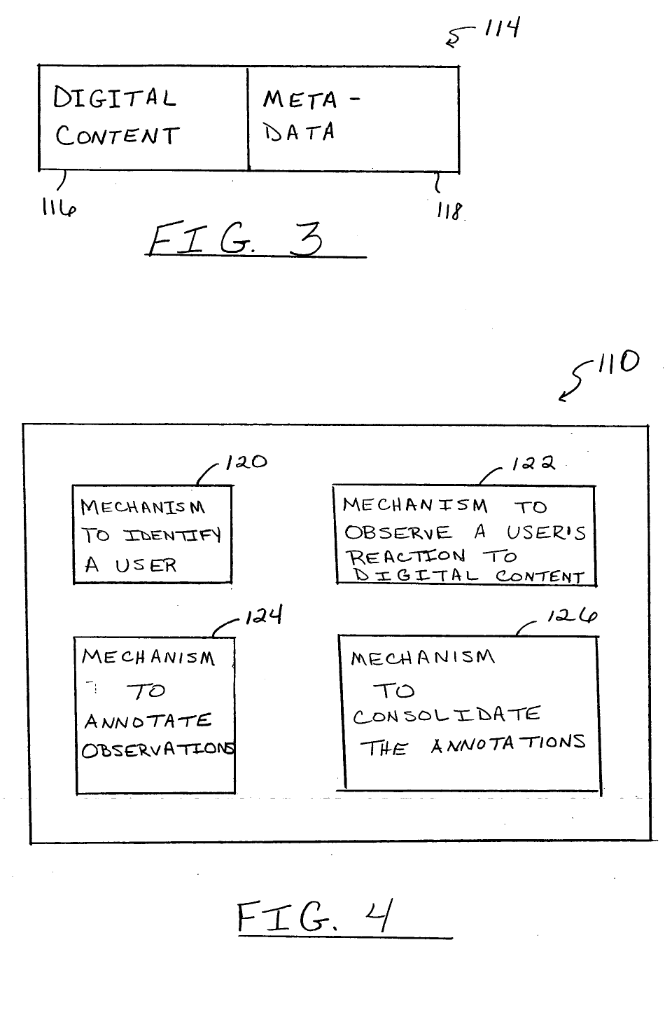

FIG. 2 is a functional block diagram of one embodiment of a receiver 104, such as the receiver 104 shown in FIG. 1. FIG. 2 is a more detailed representation of an example embodiment of the receiver 104 shown in FIG. 1. In an example embodiment, the receiver 104 comprises one or more inputs 108, one or more processing modules 110 and one or more outputs 112.

In one embodiment, the inputs 108 represent data about a user's response to digital content. In another embodiment, the inputs 108 also represent data to identify a user. A user is any entity that interacts with or makes use of digital content. In an example embodiment, a user is an individual and the data about the user's response to digital content represents the individual's opinion. In alternate embodiments, examples of users include consumers, communities, organizations, corporations, consortia, governments and other bodies. In this alternate embodiment, the data about the user's response represents an opinion of a group. For example, the users may be an audience at a movie theater. In one embodiment, the data about the user's response represents individual opinions of members of the audience at the movie theater. In an alternate embodiment, the data about the user's response represents a single group opinion for the entire audience at the movie theater.

Embodiments of the invention are not limited to any particular type of data about a user's response to digital content. Some types of data about a user's response include, but are not limited to, data from physiological processes, data from nonverbal communications, data from verbal communications, and data from the user's browsing or viewing patterns. Some examples of data from physiological processes include breathing, heart rate, blood pressure, galvanic response, eye movement, muscle activity, and the like. Some examples of data from nonverbal communications include data representing facial gestures, gazing patterns, and the like. Some examples of data from verbal communications include speech patterns, specific vocabulary, and the like. Some examples of data from the user's browsing or viewing patterns include the length of time spent viewing the digital content and the number of times the digital content is viewed.

Outputs 112 represent the result produced by the processing module 110 in response to the inputs 108. An example output 112 is user-specific meta-data associated with the digital content. The user-specific meta-data describes the user's response to the digital content. The meta-data is generated automatically from the user's reactions. The meta-data generation is transparent to the user. Another example output 112 is data representing a ranking of the digital content based on the user's responses. In example embodiments in which it is desirable for the ranking to have statistical relevance, user reactions are collected from a statistically significant number of users. In still another embodiment, the output 112 provides an automatic ethnographic ranking system for digital content.

FIG. 3 is a block diagram of a data structure according to one embodiment of the invention. The data structure 114 comprises digital content 116 and associated meta-data 118. The meta-data 118 is data about the digital content 116. According to an example embodiment of the invention, the meta-data 118 comprises one or more annotations representing a user's response to the digital content 116. In another embodiment, the meta-data 118 also identifies an originator (shown in FIG. 1 as element 102) of the digital content 116.

An annotation is a comment or extra information associated with the digital content. Embodiments of the invention are not limited to any particular type of annotation. In an example embodiment, the annotations are attributes of the user's response. Example attributes include a length of time spent browsing a given image, a number of times a given image is forwarded to others, or a galvanic response (excitement, nervousness, anxiety, etc.). Embodiments of the invention are not limited to meta-data annotations with to these attributes though. Any parameter of a user's response to digital content can be annotated in the meta-data 118.

In one embodiment, the meta-data schema is a database record (tuple) that describes the attributes of the user's response (i.e. the kinds of parameters being measured). In a system with multiple users, the multiple user responses are kept as a list of individual responses in the meta-data 118 according to one embodiment of the invention. In an alternate embodiment, statistical summaries are generated from the multiple user responses. The statistical summaries are kept in the meta-data 118 rather than the individual responses. An example of a statistical summary is a value for an average anxiety response.

Referring back for FIG. 2, the processing modules 110 comprise software and/or hardware modules that generate the meta-data 118 based on the viewer's response. Generally, the processing modules 110 include routines, programs, objects, components, data structures, etc., that perform particular functions or implement particular abstract data types.

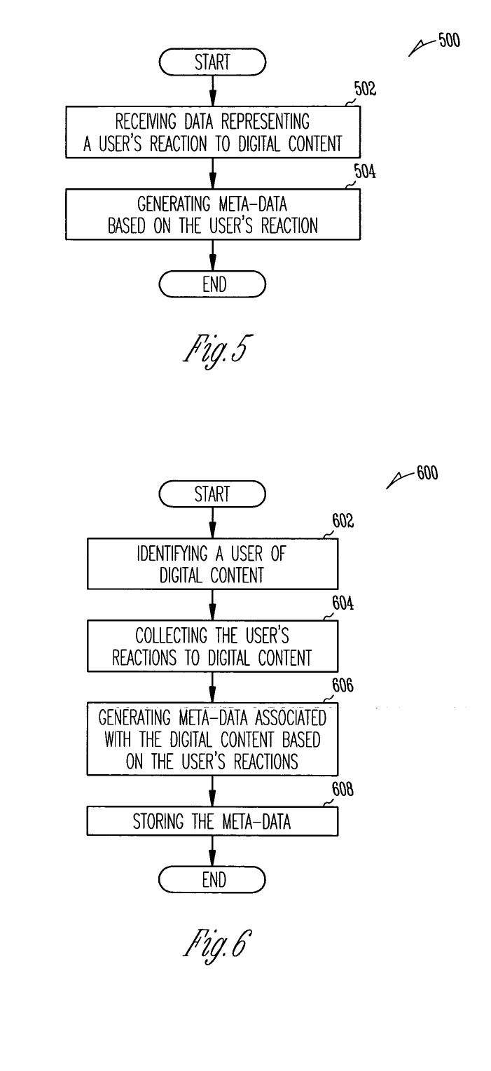

FIG. 4 is a more detailed block diagram of an example embodiment of a processing module such as the processing module 110 shown in FIG. 2. As shown in FIG. 4, the processing module 110 comprises a mechanism to identify a user 120, a mechanism to observe a user's reaction to digital content 122, a mechanism to annotate observations 124, and a mechanism to consolidate the annotations 126.

First, as shown in FIG. 4, the mechanism to identify a user 120 determines who is actually consuming the digital content. In some embodiments, a receiver (shown in FIG. 1 as element 104) is a multiple-user machine such as a television or a computer. In this case the user viewing the content is not always the same user. For example, different members of a family may watch the same television. In one embodiment, each member of the family is a different user. In an alternative embodiment the family is considered a group and the average reactions would then be recorded as group meta-data 118.

Embodiments of the invention are not limited to any particular mechanism to identify a user 120. Some example mechanisms to identify a user 120 include, but are not limited to, biometric identification devices and electronic identification devices. Some examples of biometric identification devices include fingerprinting technology, voice recognition technology, iris or retinal pattern technology, face recognition technology (including computer vision technologies), key stroke rhythm technology, and other technologies to measure physical parameters. Some examples of electronic identification devices include radio frequency tags, badges, stickers or other identifiers that a user wears or carries to identify themselves. Other examples of electronic identification devices include devices that are remote from the user such as a smart floor or carpet that identifies a user.

Second, as shown in FIG. 4, the mechanism to observe a user's reaction to digital content 122 collects data about the user's response. In some embodiments, the mechanism to observe a user's reaction to digital content 122 is a system that observes emotional responses or a system that observes how people react to different stimuli. In one embodiment, the mechanism to observe a user's reaction 122 senses states like boredom, anxiety, engagement, interest, happiness and other emotional states or moods.

Embodiments of the invention are not limited to any particular mechanism to observer a user's reaction 122 to the digital content. Some example mechanisms to observe a user's reaction 122 include sensors that are in physical contact with the user and other examples include sensors that are not in physical contact with the user. Examples of sensors that are in physical contact with the user include sensors placed in items that the user handles or touches such as a computer mouse, a keyboard, a remote control, a chair, jewelry, accessories (such as watches, glasses, or gloves), clothing, and the like. Examples of sensors that are not in physical contact with the user include cameras, microphones, active range finders and other remote sensors.

In some embodiments, the mechanism to observe a user's reaction to the digital content 122 collects data from the user passively. In alternate embodiments, the mechanism to observe a user's reaction to digital content 122 collects data from the user through active user input. In one embodiment, the mechanism to observe the user's reaction 122 includes functions for the user to expressly grade the digital content. In one example, a remote control includes buttons for a user to indicate their response to the digital content.

In some embodiments, the data collected by the mechanism to observe a user's reaction to the digital content 122 includes data about physiological processes, data about viewing and/or browsing patterns, and data about verbal or nonverbal communication as previously described in detail by reference to FIG. 2. In one embodiment, the mechanism to observe a user's reaction to digital content 122 collects nonverbal communication data using computer vision technology for gaze tracking. In this embodiment, the data collected indicates whether or not the user is paying attention to the digital content being displayed. In another embodiment, the mechanism to observe a user's reaction to digital content 122 collects data about the user's viewing and/or browsing patterns. Data about the user's viewing and/or browsing patterns is collected by monitoring keyboard and mouse usage by the user. Data about the user's viewing and/or browsing patterns is also collected by monitoring usage of a remote control by the user. In one example, data from the usage of the remote control indicates if a user is fast-forwarding through a movie or if the user is pausing the movie at particular scenes. In another example, data from the usage of the remote control indicates if a user stops watching a movie before the movie is over. In still another example, data from the usage of the remote control indicates if the user is flipping between channels. In some embodiments, the data collected by the mechanism to observe a user's reaction to the digital content 122 includes data about physiological processes, data about viewing and/or browsing patterns, and data about verbal or nonverbal communication as previously described in detail by reference to FIG. 2.

Third, as shown in FIG. 4, the mechanism to annotate meta-data 124 annotates the meta-data with user-specific responses to the digital content. The user-specific meta-data is associated with digital content and includes annotations representing the user's reaction to the digital content. In one embodiment, the observations from one or more users are collected by a receiver (shown in FIG. 1 as element 104) and stored locally by the receiver (such as by a set top box, a client computer, a server computer, etc.)

Embodiments of the invention are not limited to a particular mechanism to annotate meta-data 124. The observations may be stored using a standardized schema for meta-data. In one embodiment, the schema for the annotation is based on MPEG-21. The Moving Picture Experts Group (MPEG) began developing a standard for “Multimedia Framework” in June 2000. The standard called MPEG-21 is one example of a file format designed to merge very different things in one object, so one can store interactive material in this format (audio, video, questions, answers, overlays, non-linear order, calculation from user inputs, etc.) MPEG-21 defines the technology needed to support “Users” to exchange, access, consume, trade and otherwise manipulate “Digital Items” in an efficient, transparent and interoperable way. In some embodiments, the digital content as described herein is a Digital Item as defined by MPEG-21.

In one embodiment the mechanism to annotate meta-data 124 filters the input data received by the mechanism to observe a user's reaction 122. In this embodiment, the annotation representing the user's reaction is derived from the input data. In other words, the content of the annotation is not the input data. For example, if the input data is a sequence of keystrokes on a keyboard and the sequence of keystrokes are used to observe a user's reaction to the digital content, the annotation is not comprised of the sequence of keystrokes. Rather, the annotation comprises data derived by from the sequence of keystrokes.

In another embodiment, the mechanism to annotate meta-data 124 identifies events from the input data. An event is an occurrence of significance identified using the input data. The event is derived from the input data and the event is annotated in the meta-data. For example, a speech is the digital content. If a crowd's response to a speech is being monitored, one event that is detected from the input data is a “loss of interest” event. A second event that is detected from the input data is an “interest” event. The “interest” event is identified, for example, by laughter or loud responses from the crowd. A third event that is detected from the input data is a “time of engagement” event. The “time of engagement” event is identified when the crowd really started paying attention to the speech. These three example events are annotated in the meta-data rather than the input data representing the crowd's response. The input data representing the crowd's response comprises, for example, motion data, facial expressions, gaze tracking, laughter, audio queues, and the like. Embodiments of the invention are not limited to any particular events. An event is any occurrence of significance that is that derived from the input data. The mechanism to annotate meta-data 124 annotates the event in the meta-data.

In another embodiment, the mechanism to annotate meta-data 124 applies rules to input data received from multiple sources to identify events, user responses or user emotions. In an example embodiment, input data is received from multiple sources including: a microphone, surveillance of keystrokes, surveillance of mouse movement, and gaze tracking. In this example, the mouse movement alone is not enough to identify the user's response. However, if the mouse is moving fast, the keystroke speed is very high, the eyes are moving left and right, then it can be inferred that the user's response is nervousness. The rules indicate that if A and B and C are present in the input data then a particular event or response has occurred.

Fourth, as shown in FIG. 4, a mechanism to consolidate the annotations 126 consolidates the annotations stored by one or more receivers (104 in FIG. 1) to one originator (102 in FIG. 1). In other words, the mechanism to consolidate the annotations 126 collects the annotations in a single location. In one embodiment, the location is the originator (102 in FIG. 1). In an alternate embodiment, the location is any location identified by the originator for consolidating the annotations. In one embodiment, an identifier for the originator of the digital content is recorded in the meta-data associated with the digital content.

The mechanism to consolidate the meta-data 126 is not limited to operating on a particular type of network. In one embodiment, the mechanism to consolidate meta-data is a peer-to-peer communications mechanism. For example, a user forwarding pictures from a personal computer to recipients using different personal computers is a peer to peer network. In alternate embodiments, the mechanism to consolidate meta-data is a client-server communications mechanism. For example, if the receiver is a set-top box and the originator of the digital content is a cable service provider broadcasting a movie. The cable service provider is a server and the set-top is the client.

In one embodiment, the mechanism to consolidate the meta-data 126 opportunistically consolidates multiple local annotations from across a network to a single originator. In this embodiment, the consolidation is initiated when the network is idle. To determine when the network is idle, network traffic is monitored and/or CPU activity is monitored. Consolidating the meta-data when the network is idle reduces the impact on isochronous traffic on the network. In alternate embodiments, the consolidation occurs at any time.

The consolidated meta-data can be used for a variety of purposes. According to an example embodiment, the consolidated meta-data provides an automatic ethnographic ranking system for the digital content. Other example uses for the consolidated meta-data are described in the example scenarios section below. However, the consolidated meta-data is not limited to the particular uses described herein.

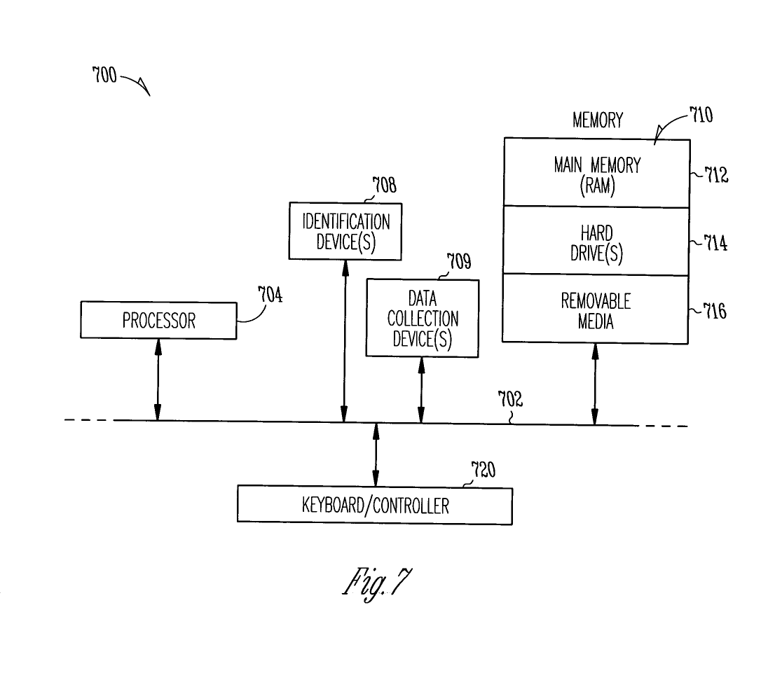

Methods. Methods of example embodiments of the invention are described by reference to FIGS. 5 and 6.

FIG. 5 is a flow diagram of a method 500 according to an example embodiment of the invention. As shown in FIG. 5, a user's reaction to digital content is received (block 502). Then meta-data based on the user's reaction is generated through computer automated operations (block 504). In alternate embodiments, the example method 500 shown in FIG. 5 also comprises generating a ranking of one or more items of digital content based on the reaction of one or more users to the digital content.

FIG. 6 is a flow diagram of a method 600 according to another example embodiment of the invention. As shown in FIG. 6, a user of digital content is identified (block 602). The user's reactions to the digital content are collected (block 604). Meta-data associated with the digital content based on the user's reactions is generated (block 606). Then, the meta-data is stored by a receiver (block 608).

In further embodiments of the invention shown in FIG. 6, meta-data from the receiver is transmitted to an originator or to a location identified by the originator. In an example embodiment, the identification of the user (block 602) is performed using an electronic identification device or a biometric identification device. The example methods performed by a system for annotating meta-data with user responses to digital content have been described; however, the inventive subject matter is not limited to the methods described by reference to FIGS. 5 and 6.

Example Scenarios. Several-example scenarios for annotating and/or using meta-data with user responses to digital content are now described. The scenarios provide examples for illustrative purposes only.

The first example scenario is directed to watching a movie. The movie is distributed as digital content from an originator over the Internet, a cable network or a satellite network. A user watches the movie on a receiver of the digital content. In this example, surveillance of the remote control, speech recognition, and active range finding are used to observe the user's reaction to the movie. If the user does not like the movie, the user may fast-forward through segments of the movie or the user may leave the room during the movie. If the movie is funny, the user may laugh or the user may say certain phrases. Thus, input data is collected by a system according to an embodiment of the present invention and used to annotate meta-data with the user's response to digital content such as a movie.

The second example scenario is directed to watching a movie on a pay-per-view system. In this example, the responses of a many users are annotated in the meta-data. The originator is a commercial distributor of pay-per-view services. The receiver is a set-top box located in many individual's homes. The originator periodically consolidates the annotations stored by each set-top box and uses the annotations to adjust the price of the movie. The price charged for a movie depends on the viewer's opinions of the movie. When a new movie is distributed, the pay-per-view fee is a standard initial fee because no opinions are available for the movie. If a viewer is one of the first consumers to watch the movie, the viewer pays the standard initial fee. However, as viewers' opinions of the movie are collected using embodiments of the present invention, the originator adjusts the price of the movie in response to the viewers' opinions. If the viewers' like the movie, the originator will increase the cost of the movie based on the annotations of the user responses. Subsequent viewers will pay more to view the movie. If the viewers dislike the movie, the originator will decrease the cost of the movie based on the annotations of the user responses. In this instance, subsequent viewers will pay less to view the movie. Thus, embodiments of the invention enable flexible pricing of digital content in response to user responses on the piece of digital content.

The third example scenario is directed to market research for future digital content. In this example scenario, the digital content is an movie or a speech. The granularity of the annotation is not limited to the entire movie or speech. The annotations may include user responses to particular portions of the movie or speech. In this example scenario, the originator performs market research and plans for future movies or speeches using the annotations. If during a particular scene of a movie 30% of the users were so bored that they fast-forwarded to the end of the scene, the originator can look in retrospect at the annotations and see that this scene was unnecessary in the movie or just boring. So, the originator analyzes the annotations for a segment of digital content and uses the analysis to plan future movies or speeches. Thus, embodiments of the invention enable market research on digital content.

The fourth example scenario is directed to analyzing audience reaction to verbal communications. Some examples of verbal communications include political or corporate speeches. In this example scenario, the annotations include responses of individuals or the audience as a whole to a speech that is broadcast to a television or Internet audience. Because the audience is not a live audience, the speaker does not get direct feedback on how the message is received by the audience and how the message may need to be revised. The annotated meta-data according to example embodiment of the invention provides a way for the speaker to receive feedback on the audience reaction to the speech. For example, if the annotations indicate that 80 percent of the audience for a political speech laugh at something that the speaker intended to be serious, then the speaker knows there is a need to revise this portion of the speech before it is delivered again. Thus, embodiments of the invention provide feedback to speakers on the audience reaction even when the audience is not a live audience.

Example Hardware and Operating Environment. FIG. 7 is a block diagram of an electronic system 700 for annotating meta-data with user responses to digital content in accordance with one embodiment of the invention. Electronic system 700 is merely one example of an electronic system in which embodiments of the present invention can be implemented. In this example, electronic system 700 comprises a data processing system that includes a system bus 702 to couple the various components of the system. System bus 702 provides communications links among the various components of the electronic system 700 and can be implemented as a single bus, as a combination of busses, or in any other suitable manner.

Processor 704 is coupled to system bus 702. Processor 704 can be of any type of processor. As used herein, “processor” means any type of computational circuit such as, but not limited to, a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), or any other type of processor or processing circuit.

Electronic system 700 can also include a memory 710, which in turn can include one or more memory elements suitable to the particular application, such as a main memory 712 in the form of random access memory (RAM), one or more hard drives 714, and/or one or more drives that handle removable media 716 such as floppy diskettes, compact disks (CDs), digital video disk (DVD), and the like.

Electronic system 700 can also include a keyboard and/or controller 720, which can include a mouse, trackball, game controller, voice-recognition device, or any other device that permits a system user to input information into and receive information from the electronic system 700.

Electronic system 700 can also include devices for identifying a user of digital content 708 and devices for collecting data representing a user's response to digital content 709.

In one embodiment, electronic system 700 is a computer system with periphal devices. However, embodiments of the invention are not limited to computer systems. In alternate embodiments, the electronic system 700 is a television, a hand held device, a smart appliance, a satellite radio, a gaming device, a digital camera, a client/server system, a set top box, a personal digital assistant, a cell phone or other wireless communication device, and so on.

In some embodiments, the electronic system 700 enables continuous ranking of digital content over the content's complete life-cycle. In one embodiment, the digital content is received by the electronic system 700. Software or hardware in the electronic system 700 monitor users' reactions and browsing patterns. In one embodiment, these measurements are annotated locally in the electronic system 700 and opportunistically consolidated globally throughout the peer-to-peer network. These meta-data are collected automatically and become unique search keys to a community of consumers. These human-derived meta-data are particularly useful, for example, to enable efficient ranking and browsing of massive media collections. As a result, an example embodiment of electronic system 700 provides an automatic ethnographic ranking system for digital content.

The present subject matter may be embodied in other specific forms without departing from the spirit or essential characteristics thereof. The present embodiments are therefore to be considered in all respects as illustrative and not restrictive, the scope of embodiments of the subject matter being indicated by the appended claims rather than by the foregoing description, and all changes which come within the meaning and range of equivalency of the claims are therefore intended to be embraced therein.

It is emphasized that the Abstract is provided to comply with 37 C.F.R. § 1.72(b) requiring an Abstract that will allow the reader to ascertain the nature and gist of the technical disclosure. It is submitted with the understanding that it will not be used to interpret or limit the scope or meaning of the claims.

In the foregoing Detailed Description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A computerized method comprising:
receiving data representing a user's reaction to digital content; and
generating through computer automated operations meta-data based on the user's reaction.

2. The method of claim 1 further comprising receiving data identifying a user.

3. The method of claim 2 further comprising generating a ranking of one or more items of digital content based on the reaction of one or more users to the digital content.

4. The method of claim 1 wherein the data representing the user's reaction is data representing an individual's reaction.

5. The method of claim 1 wherein the data representing the user's reaction is data representing a group's reaction.

6. The method of claim 1 wherein receiving data representing a user's reaction further comprises receiving data representing physiological processes.

7. The method of claim 6 wherein the data representing physiological processes is selected from the group consisting of breathing, heart rate, blood pressure, galvanic response, eye movement, and muscle activity.

8. The method of claim 1 wherein receiving data representing the user's reaction further comprises receiving data representing nonverbal communications.

9. The method of claim 8 wherein the data representing nonverbal communications is data representing facial gestures.

10. The method of claim 8 wherein the data representing nonverbal communications is data representing gazing patterns of the user.

11. The method of claim 1 wherein the receiving data representing the user's reaction further comprises receiving data representing verbal communications.

12. The method of claim 11 wherein the data representing verbal communications comprises data representing speech patterns.

13. The method of claim 11 wherein the data representing verbal communications comprise data representing the user's vocabulary.

14. The method of claim 1 wherein receiving data representing the user's reaction further comprises receiving data representing the user's pattern used to browse the digital content.

15. A method comprising:
identifying a user of digital content;
collecting the user's reactions to digital content;
generating meta-data associated with the digital content based on the user's reactions; and
storing the meta-data by the a receiver.

16. The method of 15 further comprising transferring the meta-data from the receiver to an originator.

17. The method of 15 further comprising transferring the meta-data from the receiver to a location identified by the originator.

18. The method of claim 15 wherein identifying a user is performed using an electronic identification devices.

19. The method of claim 18 wherein the electronic identification device is worn by the user.

20. The method of claim 18 wherein the electronic identification device is carried by the user.

21. The method of claim 18 wherein the electronic identification device is remote from the user.

22. The method of claim 15, wherein identifying a user is performed using a biometric identification device.

23. The method of claim 20 wherein the biometric identification device is selected from the group consisting of a fingerprinting device, a voice recognition device, an iris pattern identification device, a retinal pattern identification device, a face recognition device, and a key stroke rhythm detection device.

24. The method of claim 15 wherein collecting the user's reactions is performed using a sensor.

25. The method of claim 24 wherein the sensor in physical contact with the user.

26. A apparatus comprising:
a mechanism to identify a user of digital content;
a mechanism to collect the user's responses to the digital content;
a mechanism to generate a plurality of meta-data associated with the digital content based on the user's responses; and
a mechanism to transfer the plurality of meta-data generated throughout a network to a location identified by an originator.

27. The apparatus of claim 26 wherein the location identified is the location of the originator.

28. The apparatus of claim 26 wherein the mechanism to identify a user further comprises one or more electronic identification devices.

29. The apparatus of claim 26 wherein the mechanism to identify a user further comprises one or more biometric identification devices.

30. The apparatus of claim 26 wherein the mechanism to collect the user's response further comprises one or more sensors.

31. The method of claim 26 wherein the mechanism to collect the user response is a device selected from the group consisting of a keyboard, a mouse, a remote control, a touchpad, a joystick, a speech recognition device, a video camera, and a microphone.

32. An electronic system comprising:
a memory to store instructions for annotating digital content;
a storage device to store meta-data associated with the digital content; and
a processor programmed to:
execute the instructions for annotating digital content from the memory,
annotate the meta-data with one or more user's responses to the digital content, and
store the meta-data on the storage device.

33. The electronic system of claim 32 further comprising one or more devices for identifying a user of digital content.

34. The electronic system of claim 32 further comprising one or more devices to collect data representing a user's response to digital content.

35. An article comprising a machine-accessible medium having associated data, wherein the data, when accessed, results in a machine performing:
receiving data representing a user's reaction to digital content; and
annotating through computer automated operations the user's reaction in meta-data associated with the digital content.

36. The article of claim 35 wherein the machine-accessible medium further includes data, wherein the data, when accessed by the machine, results in the machine performing identifying the user.

37. The article of claim 35 wherein the machine-accessible medium further includes data, when accessed by the machine, results in the machine performing transferring the meta-data to a designated location.

38. An article comprising a machine-accessible media having associated data, wherein the data comprises a data structure for use by the machine, the data structure comprising:
a first field containing data representing digital content; and
a second field containing data representing meta-data associated with the digital content wherein the meta-data comprises one or more annotations representing a user's response to the digital content.

39. The article of claim 38 wherein the machine-accessible media further includes data, wherein the data comprises a data structure for use by the machine, the data structure comprising a third field containing data representing an originator of the digital content.

40. The article of claim 38 wherein the machine-accessible media further includes data, wherein the data comprises a data structure for use by the machine, wherein the data representing the digital content is a Digital Item.

41. The article of claim 38 wherein the machine-accessible media further includes data, wherein the data comprises a data structure for use by the machine, wherein the data representing meta-data is stored using a schema based on MPEG-21.

42. The article of claim 38 wherein the machine-accessible media further includes data, wherein the data comprises a data structure for use by the machine, wherein the annotation identifies an event.

43. The article of claim 38 wherein the machine-accessible media further includes data, wherein the data comprises a data structure for use by the machine, wherein the data representing meta-data comprises responses from multiple users.

44. The article of claim 38 wherein the machine-accessible media further includes data, wherein the data comprises a data structure for use by the machine, wherein the data representing meta-data comprises statistical summaries of response from multiple users.

45. A system comprising:
means to identify a user of digital content;
means to collect the user's reactions to digital content;
means to generate meta-data associated with the digital content based on the user's responses/reactions; and
means to consolidate in a local database the multiple meta-data generated throughout the network.

46. The system of claim 45 further comprising means to provide a ranking based on the consolidated meta-data.

47. The system of claim 45 further comprising means to browse selected items of digital content based on the meta-data.

48. A computerized method comprising:
automatically consolidating, from across a network, a plurality of meta-data describing a plurality of user's responses to digital content.

49. The computerized method of claim 48 wherein consolidating the meta-data is performed when a network is idle.

50. The computerized method of claim 48 further comprising adjusting a price for the digital content in response to the user responses to the digital content annotated in the meta-data.

51. The computerized method of claim 48 further comprising conducting market research using the user responses to the digital content annotated in the meta-data.

52. The computerized method of claim 48 further comprising analyzing verbal communication delivered in the form of digital content, the analyzing performed using user responses to the digital content annotated in the meta-data.

53. The computerized method of claim 48 wherein the consolidated meta-data provides an automatic ethnographic ranking system for digital content.
